(19) United States
(12) Patent Application Publication
(10) Pub. No.: US 2008/0238639 A1
(43) Pub. Date: Oct. 2, 2008

(54) Automobile auxiliary light testing device

(76) Inventor: James Hopkins, Flagstaff, AZ (US)

Correspondence Address: Raymond M. Galasso;Galasso & Associates LP, P.O Box 26503, Austin, TX, 78755-0503, US

(21) Appl. No.: 11/732,333

(22) Filed: Apr. 2, 2007

(51) Int. Cl. G08B 5/00

(52) U.S. Cl. 340/431

(57) ABSTRACT

A testing device operable to test a tow vehicle's trailer light control system with the testing device operable to determine whether or not, subsequent to being operably connected to a tow trailer wiring harness of the tow vehicle, the tow vehicle's trailer light control system can transmit the required voltage to operate the light system of the tow trailer. The testing device further includes a housing which has disposed therein a plurality of test lights. A controller operable connects the test lights to a terminal assembly which is electrically coupled to the tow vehicle. The test lights are configured to illuminate subsequent to receiving the required voltage to operate a portion of the light system of a tow trailer.

### FIELD OF THE INVENTION

The present invention relates to an auxiliary light testing device more specifically but not by way of limitation, a light testing device to test the electrical signals generated from a vehicle's wiring harness with such wiring harness configured to operably connect with a wiring harness of tow vehicle such as a trailer.

### BACKGROUND

Outdoor recreational activities are participated in by millions of individuals every year. These activities can range from hunting, boating and camping. In order to engage in these activities, individuals often purchase or rent items such as camping trailers, boats or all terrain vehicles.

Many of the aforementioned items are usually transported to the desired destination on a tow trailer that is designed to be towed with an appropriate vehicle such as an automobile or truck. A camping trailer or a typical tow trailer that is designed to transport items such as a boat or all terrain vehicles is equipped with the basic lights that are required by state law. A standard lighting system on a vehicle trailer will contain at a minimum rear tail lights and turn signal lights and running lights for nighttime driving. Larger conventional fifth wheel trailers such as but not limited to camping trailers will have lighting systems that further contain marker lights and reverse indicator lights.

Routine inspection and testing of the trailer light circuits are necessary in order to abide with state law and for good safety habits. In most configurations the trailer light connector is operably engaged with the wiring harness of the vehicle proximate the connection of the tow trailer and the vehicle. During testing and troubleshooting procedures, it is routinely recommended that a complete light circuit be diagnosed in separate operable components if possible.

One problem user's encounter when diagnosing a trailer light problem is determining whether or not the issue is with the electrical signal production from the tow vehicle or with the wiring system on the trailer itself. Without a method of isolating the operable components of the lighting circuit, a user can not reasonably assess whether or not the issue resides in the lighting circuit of the vehicle or on the trailer. This can create a significant inconvenience for any individual that is testing the trailer light circuits and attempting to diagnose a lighting problem.

Accordingly, there is a need for a device that is capable of allowing a user to test the electrical signals generated from the wiring harness of the tow vehicle without the requirement of operably engaging a tow trailer.

### SUMMARY OF THE INVENTION

It is the object of the present invention to provide a testing device that is configured to operably engage with the wiring harness of a tow vehicle in order to test the electrical signals that operate a plurality of lights.

A further object of the present invention is to provide a tow vehicle light testing device that can operably engage with a plurality of available trailer light couplers.

Another object of the present invention is to provide a testing device that is configured to operably engage with the wiring harness of a tow vehicle that is easy to use.

A further object of the present invention is to provide a testing device that is configured to operably engage with the wiring harness of a tow vehicle in order to test electrical signals that is relatively inexpensive.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawing wherein:

FIG. 1 is a perspective view of an embodiment of the present invention; and

FIG. 2 is a perspective view of an embodiment of the present invention with the top housing removed.

### DETAILED DESCRIPTION

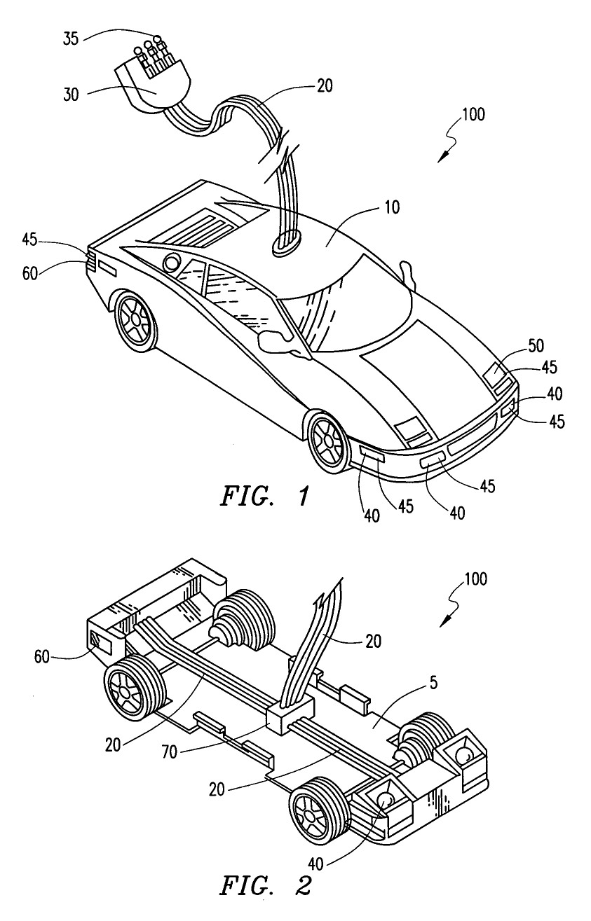

Referring now to the drawings submitted herewith wherein the various elements depicted therein are not necessarily drawn to scale and wherein like elements are identified with like reference numerals and in particular to FIGS. 1 and 2, there is illustrated a preferred embodiment of a trailer light testing device 100.

The trailer light testing device 100 comprises a top housing 10 manufactured from a suitable durable material such as but not limited to plastic. The housing 10 is superposed by suitable mechanical or chemical methods to a frame 5 and is configured to have an internal volume sufficient in size to have disposed therein a controller 70 and the control wire 20 (see FIG. 2). It is further contemplated within the scope of the present invention that the housing 10 substantially inhibits water from propagating into the trailer light testing device 100. Although the housing 10 is shown in the drawings submitted herewith as having an embodiment with the likeness of a vehicle, it is contemplated within the scope of the present invention that the housing 10 could be formed to resemble the appearance of numerous different objects. More specifically but not by way of limitation, the housing 10 could be manufactured to resemble the appearance of a truck.

A terminal assembly 30 functions to electrically couple the trailer light testing device 100 to a vehicle that is equipped with a mating receptacle. The terminal assembly 30 has integrally mounted thereon a plurality of terminal leads 35 that function to electrically couple the control wire 20 to a plurality of test lights 45 with the portion of the electrical circuit of a vehicle's wiring harness that generates the necessary voltage for controlling the operating lights of a vehicle such as but not limited to brake lights, turn signal lights, running lights, and emergency flashers. The terminal assembly 30 further connects to the electrical ground of the vehicle. The terminal assembly 30 as illustrated in the FIG. 1 submitted herewith is a conventional flat four-way trailer light connector. Those skilled in the art will recognize that the terminal assembly 30 could be configured with a variety of different style connectors to accommodate a plurality of trailer light receptacles. More specifically but not by way of limitation, the terminal assembly 30 could be configured as a conventional six-way or seven-way trailer light connector.

The control wire 20 operably connects the terminal assembly 30 to a plurality of test lights 45. The control wire 20 is manufactured from suitable material such as but not limited to insulated copper wire. The control wire 20 consists of a plurality of wires that transmit the voltage generated by a portion of an operably connected tow vehicle thereby illuminating the test light 45. As is known in the art, most tow trailers have at least a circuit for brake lights, turn signal lights and nighttime running lights. The trailer light testing device 100 contains test lights 45 that will illuminate when they are operably engaged with the wiring harness of a tow vehicle and the required voltage successfully transmits to the test lights 45. If the required voltage to operate trailer lights is not transmitted, the test lights 45 will not illuminate thereby indicating to the user that at least a portion of the vehicles wiring harness controlling the lights is not transmitting properly to the electrically coupled terminal assembly 30.

The trailer light testing device 100 includes brake light indicators 60, turn signal indicators 40 and running light indicators 50 that function to signal to a user when the trailer light testing device 100 is operably connected to a tow vehicle that those portions of the wiring harness are producing the required voltage to power a trailer light system. Those skilled in the art will recognize that the electrical signal or voltage produced by most tow vehicles is a twelve volt DC current. It is contemplated within the scope of the invention that the trailer light testing device 100 could be manufactured to operate with a plurality of different voltages.

The control wire 20 is intermediate controller 70 and the terminal assembly 35 and is journaled through the housing 10. The control wire 20 is divided at the controller 70 in order to direct the electrical signal required to the test lights 45 on the trailer light testing device 100. Subsequent to operably connecting the trailer light testing device 100 to a tow vehicle the electrical signal generated by the tow vehicle's light circuit are directed to the corresponding test light 45. The turn signal light indicators 40 will illuminate subsequent to the required electrical signal being successfully transmitted through the control wire 20 to the turn signal light indicators 40 from the portion of the vehicle's wiring harness that controls the turn signal lights of the vehicle. It is contemplated within the scope of the present invention that the turn signal indicators 40 include testing for each turn direction and that the turn signal light indicators 40 will flash in coordination with the flashing of the tow vehicle's turn signal lights. The brake light indicators 60 will illuminate subsequent to the required electrical signal being successfully transmitted via the control wire 20 to the brake light indicators 60. Nighttime running lights are verified subsequent to successful transmission of the required electrical signal to the running light indicators 50 resulting in illumination thereof. It is further contemplated within the scope of the present invention that all of the test lights 45 will illuminate at a lower intensity when the nighttime running light circuit of the tow vehicle is activated and operably engaged with the trailer light testing device 100.

The test lights 45 are manufactured of a suitable light transmitting material such as but not limited to an LED light. Those skilled in the art will recognize that numerous different types of lights that could be utilized in order to achieve the function as described herein of the test lights. It is also contemplated within the scope of the present invention that the test lights 45 could be a variety of colors. More specifically but not by way of limitation, the test lights 45 could be orange, red or white.

Referring in particular to FIG. 1, a description of the operation of the trailer light testing device 100 is as follows. In use, a user will connect the terminal assembly 30 to a mating receptacle mounted on a tow vehicle. Subsequent to electrically coupling the terminal assembly 30, the user then individually activates the desired lights on the tow vehicle to verify that the required electrical signal is being produced and transmitted to the mating receptacle thereby indicating that the various light circuits of the tow vehicle are functioning properly and the required electrical signals to operate any operably connected tow trailer are being transmitted to the receptacle on the tow vehicle.

When a user activates the brake pedal of the operably connected tow vehicle, the brake light indicators 60 will illuminate if the electrical signal is successfully transmitted thereto. Following activation of the nighttime running lights of the operably connected tow vehicle, the test lights 45 will illuminate at a lower intensity than for other tests if the required electrical signal is transmitted to the test lights 45. To verify the required turn signal voltage, a user will independently activate the left and right turn signals of the tow vehicle. The operably engaged trailer light testing device 100 will then illuminate the corresponding turn signal light indicators 40 if the required electrical signal is transmitted thereto. If all or a portion of the test lights 45 do not illuminate when the corresponding light on the electrically coupled tow vehicle are activated this functions to indicate to the user that a problem exists with that portion of the tow vehicle light circuit and the required voltage is not being transmitted. Once all of the desired lights have been tested and verification of the light circuit portion of the tow vehicles wiring harness is complete the trailer light testing device 100 is disconnected from the tow vehicle.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A testing device for a tow vehicle's trailer light control system, with the testing device operable to verify the operation of the tow vehicle's trailer light control system, the testing device comprising:
a plurality of test indicators, with each of said plurality of test indicators operable to generate a signal; and
a controller configured to be operably connected between said plurality of test indicators and the tow vehicle's trailer light system, said controller operable to control the operation of each of said plurality of test indicators in response to the operation of the tow vehicle's trailer light control system.

2. The testing device as recited in claim 1, wherein at least one of said plurality of test indicators includes a light wherein said signal generated by said at least one of said plurality of test indicators is a light signal.

3. The testing device as recited in claim 2, wherein said plurality of test indicators operate in response to the operation of at least one of the brake lights and turn signal lights of the tow vehicle.

4. The testing device as recited in claim 3, wherein said controller includes a terminal assembly, said terminal assembly being a four-way trailer light receptacle configured to mate with a four-way trailer light receptacle of the tow vehicle.

5. The testing device as recited in claim 4, and further including a housing with said plurality of said test indicators substantially disposed therein, said housing configured to inhibit water from coming in contact with said plurality of said test indicators.

6. The testing device as recited in claim 5, wherein said at least one of said plurality of test indicators is a twelve volt dc light.

7. The testing device as recited in claim 6, wherein said at least one of said plurality of test indicators in an LED lights.

8. A voltage tester comprising:
a housing; and
a plurality of indicators positioned within said housing, said plurality of indicators being configured to be operably connected to an external voltage source, each of said plurality of indicators producing a signal to a user subsequent to each of said plurality of indicators receiving a voltage exceeding a predetermined amount from said voltage source, each of said indicators operable between a first mode and a second mode.

9. The voltage tester as recited in claim 8, and further including control wires, said control wires configured to operably engage said plurality of indicators with the external voltage source.

10. The voltage tester as recited in claim 9, wherein said plurality of indicators are test lights operable to generate light.

11. The voltage tester as recited in claim 10, wherein said signal is the generation of light by said test lights subsequent to said test lights receiving a voltage from the external voltage source.

12. The voltage tester as recited in claim 11, wherein when each of said test lights generate light, each of said plurality of indicators are operating in said first mode.

13. The voltage tester as recited in claim 12, wherein the voltage source including brake lights and turn signals, and further wherein said indicators produce said signal corresponding to the activation of the brake lights and turn signals of the voltage source.

14. The voltage tester as recited in claim 13, and further including a terminal assembly, said terminal assembly configured for connection to the voltage source.

15. A device for testing the capability of a vehicle to operate the light system of a tow trailer, said device comprising:
a plurality of test indicators, each of said test indicators configured to produce a signal when operably connected to the light system of the vehicle;
a controller connected to each of said plurality of test indicators, said controller further configured to electrically engage the light system of the vehicle; and
said controller including a terminal assembly, said terminal assembly for facilitating the connection of the vehicle light system to the device for testing.

16. The device as recited in claim 15, wherein said plurality of test indicators includes a plurality of lights, each said plurality of lights being operably connected to said controller, each of said plurality of lights operable to produce light in response to receiving a required voltage from the vehicle.

17. The device as recited in claim 16, wherein said terminal assembly includes a four-way trailer light connection receptacle.

18. The device as recited in claim 17, wherein at least one of said plurality of lights is operable connected to the vehicle and further configured to illuminate in response to the activation of at least one of the brake lights and turn-signals of the vehicle.

19. The device as recited in claim 18, and further including a housing configured to receive therein said plurality of test indicators, said housing further configured to inhibit water from coming into contact with said plurality of said test indicators.

20. The device as recited in claim 19, wherein said housing is configured to have the physical appearance of an automobile
